(19) United States
(12) Patent Application Publication
(10) Pub. No.: US 2014/0089158 A1
(43) Pub. Date: Mar. 27, 2014

(54) ACCOUNT MANAGEMENT SYSTEM AND METHOD

(71) Applicants: SI-QUAN CHEN, Tu-Cheng (TW); WEI-HONG HUANG, Shenzhen City (CN); CHAO-JUN XIAO, Shenzhen City (CN)

(72) Inventors: SI-QUAN CHEN, Tu-Cheng (TW); WEI-HONG HUANG, Shenzhen City (CN); CHAO-JUN XIAO, Shenzhen City (CN)

(21) Appl. No.: 13/662,580

(22) Filed: Oct. 29, 2012

(30) Foreign Application Priority Data
Sep. 25, 2012 (CN) 2012103599699

(51) Int. Cl. G06F 21/00; G06F 7/04; G06Q 40/04

(52) U.S. Cl. 705/37; 726/5

(57) ABSTRACT

An account management method is provided. The account management method includes steps: storing accounts and a user password for each account; receiving account information, and determining whether the account information matches one of the account information of the accounts; receiving a password; validating whether the user has an authority to set a delegating password and delegating authority for the account, and setting the delegating password and the delegating authority for the matched account when the user has the authority, wherein the delegating authority defines at least one authorized operation; comparing the received password with the user password and/or the delegating password to determine the received password is the user password or the delegating password; and implementing an operation when the received password is the user password or an authorized operation when the received password is the delegating password.

### BACKGROUND

1. Technical Field

The present disclosure relates to account management systems and, particularly, to an account management system and a method for managing a delegated authority for accounts.

2. Description of Related Art

Users usually authorize an agent to manage accounts such as, bank accounts, game accounts etc. when the users don't have time to do so. During a process of authorization, the users will tell the agent about the account to be managed and a password to login the account. However, in prior arts, only one password is assigned to one account, it is difficult to control a range of permitted operations of the agent after the agent has known the password of the account, thereby posing a risk for funds or data in the account.

Therefore, what is needed is an account management system and a method for managing a delegated authority for accounts to overcome the described limitations.

### BRIEF DESCRIPTION OF THE DRAWINGS

FIG. 1 is a block diagram of the hardware infrastructure of an account management system, in accordance with an exemplary embodiment.

FIG. 2 is a flowchart of setting a delegating password and a delegated authority for an account in a database implemented by the account management system of FIG. 1, in accordance with an exemplary embodiment.

FIG. 3 is a flowchart of managing the delegated authority of the account in the database implemented by the account management system of FIG. 1, in accordance with an exemplary embodiment.

### DETAILED DESCRIPTION

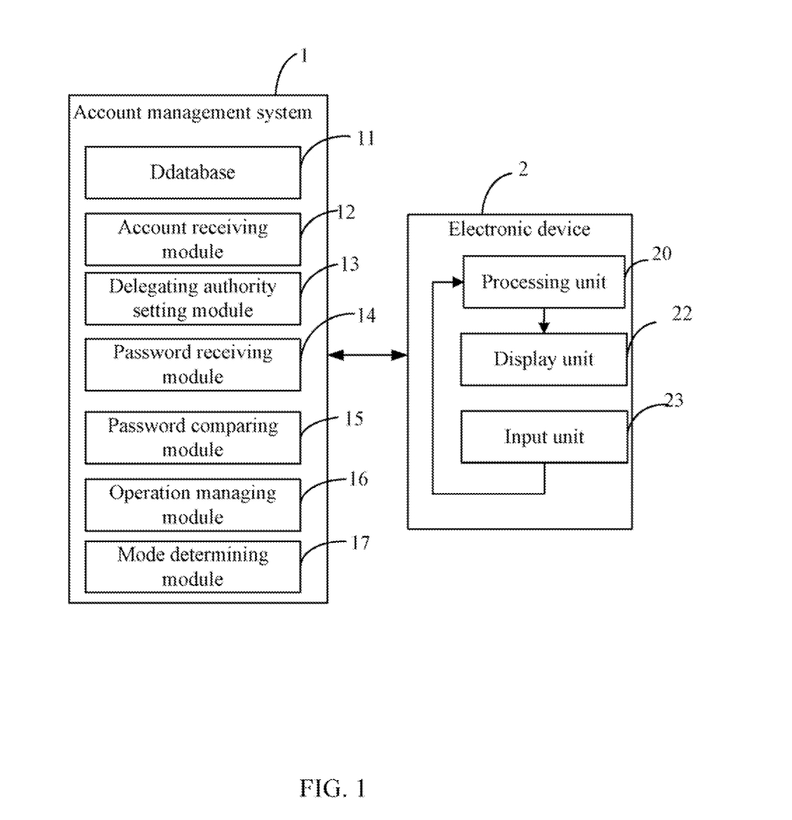

FIG. 1 is a block diagram of the hardware infrastructure of an account management system, in accordance with an exemplary embodiment. The account management system 1 is applied to at least one electronic device 2, and is to be executed by at least one processing unit 21 of the electronic device 2.

The account management system 1 includes a database 11 and a number of modules to be executed by the processing unit 21. The database 11 stores a number of accounts and a user password, a delegating password, and a delegating authority associated with the delegating password for each of the number of accounts. The accounts may be bank accounts, or game accounts, for example.

The number of modules to be executed by the processing unit 21 includes an account receiving module 12, a delegated authority setting module 13, a password receiving module 14, a password comprising module 15, and an operation managing module 16.

The account receiving module 12 receives account information input from an input unit 23 of the electronic device, and determines whether the received account information matches one of the account information of the accounts in the database 11. The delegating authority setting module 13 validates whether a user/administrator has an authority to set a delegating password and delegating authority for the matched account in response to a setting operation of the user when the received account information matches one of the account information of the accounts in the database 11, and sets the delegating password and the delegating authority for the received account when the user/administrator has the authority. In one embodiment, the delegating authority defines at least one authorized operation. In one embodiment, the delegating authority setting module 13 determines whether the received password matches the user password or an administrative password to determine whether the user/administrator has an authority to set a delegating password and delegating authority for the matched account.

The password receiving module 14 receives a password input from the input unit 23. The password comparing module 15 compares the received password with the user password or the delegating password to determine whether the received password is the user password or the delegating password. The operation managing module 16 implements an operation for the account in response to user operations when the received password is the user password. The operation managing module 16 implements one of the at least one authorized operation for the account in response to agent operations when the received password is the delegating password.

In one embodiment, the number of modules further includes a mode determining module 17. The mode determining module 17 determines whether the received account information has the delegating password, and displays a user mode and a delegating mode on a display unit 22 of the electronic device 2 when thmatched account has the delegating password. The password receiving module 14 receives a password, the password comparing module 15 determines whether the received password matches the user password when the user chooses the user mode, the operation managing module 16 implements the operation for the account in response to user operations when the input password matches the user password. The password comparing module 15 further determines whether the received password matches the delegating password when the user chooses the delegating mode, the operation managing module 16 implements the authorized operation for the account in response to agent operations when the input password matches the delegating password.

In another embodiment, the password comparing module 15 compares the received password with the user password and the delegating password respectively when the account has the user password and the delegating password, and determines the received password is the user password when the received password matches the user password or the received password is the delegating password when the received password matches the delegating password.

In one embodiment, the delegating authority stores a start time for implementing the authorized operation and an end time for ending the authorized operation. The operation managing module 16 determines whether current time is between the start time and the end time when the received password matches the delegating password. The operation managing module 16 implements the authorized operation for the account when the current time is between the start time and the end time. Otherwise, the operation managing module 16 does not implement the authorized operation.

In one embodiment, the delegating authority further stores a limited value for exchange traded funds. The operation managing module 16 determines whether current exchange traded funds is less than the limited value of the exchange traded funds when the received password matches the delegating password. The operation managing module 16 implements the authorized operation for the account when the current exchange traded funds is less than the limited value of the exchange traded funds. Otherwise, the operation managing module 16 does not implement the authorized operation.

In one embodiment, the delegating authority further stores a predetermined time of use of the delegating operation and a current time of use of the delegating operation. The operation managing module 16 increases the current time of use time one when the received password matches the delegating password, and determines whether the current time of use is less than the predetermined time of use. The operation managing module 16 implements the authorized operation for the account when the current time of use is less than the predetermined time of use. Otherwise, the operation managing module 16 does not implement the authorized operation.

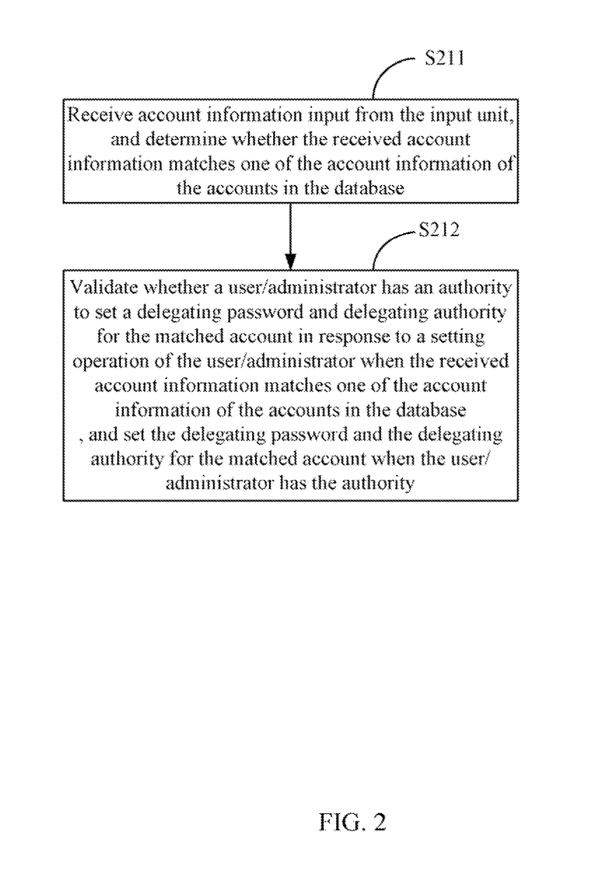

FIG. 2 is a flowchart of setting a delegated authority for an account implemented by the account management system of FIG. 1, in accordance with an exemplary embodiment.

In step S211, the account receiving module 12 receives account information input from the input unit, and determines whether the received account information matches one of the account information of the accounts in the database 11.

In step S212, the delegating authority setting module 13 validates whether a user/administrator has an authority to set a delegating password and delegating authority for the matched account in response to a setting operation of the user/administrator when the received account information matches one of the account information of the accounts in the database 11, and sets the delegating password and the delegating authority for the matched account when the user/administrator has the authority.

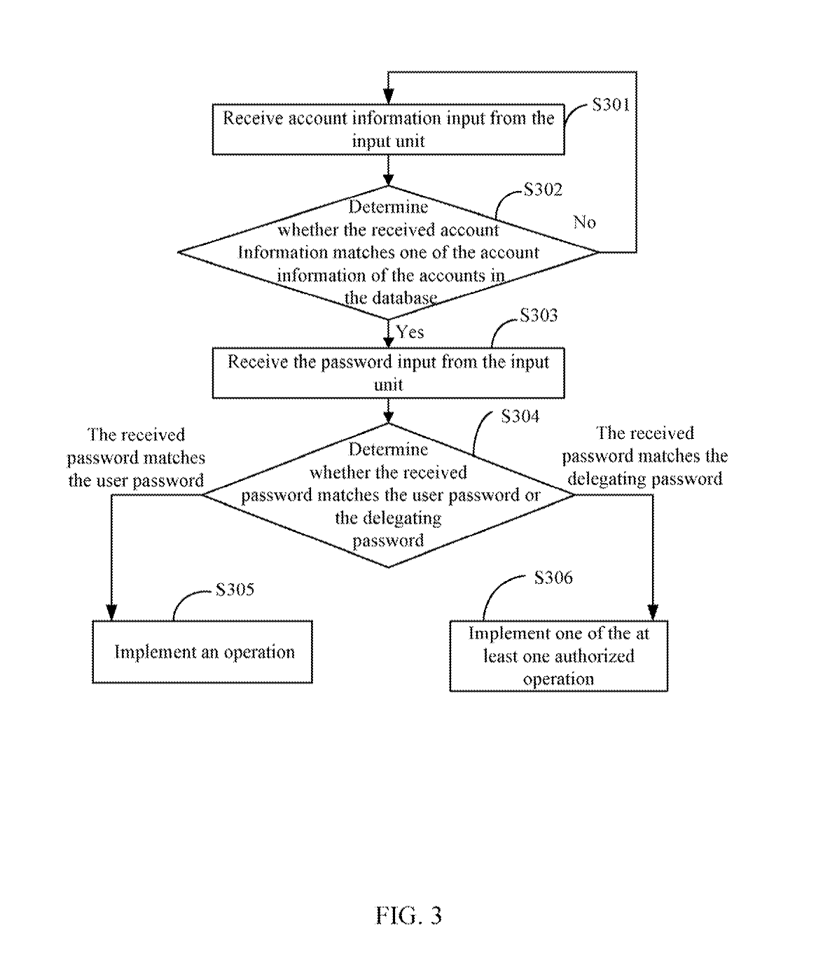

FIG. 3 is a flowchart of managing the delegated authority of the account stored in the database implemented by the account management system of FIG. 1, in accordance with an exemplary embodiment.

In step S301, the account receiving module 12 receives account information input from the input unit 23.

In step S302, the account receiving module 12 determines whether the received account information matches one of the account information of the accounts in the database 11, if yes, the procedure goes to step S303, if no, the procedure goes to step S301.

In step S303, the password receiving module 14 receives the password input from the input unit.

In step S304, the password comparing module 15 determines whether the received password matches the user password or the delegating password.

In step S305, the operation managing module 16 implements the operation when the received password matches the user password.

In step S306, the operation managing module 16 implements the authorized operation when the received password matches the delegating password.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An account management system comprising:
a database configured to store a plurality of accounts and a user password for each of the plurality of accounts,
at least one processor;
a plurality of modules to be executed by the at least one processor, wherein the plurality of modules comprises:
an account receiving module configured to receive account information, and determine whether the received account information matches account information of one of the accounts in the database;
a password receiving module configured to receive a password when the received account information matches account information of one of the accounts in the database;
a delegating authority setting module configured to validate whether a user/administrator has an authority to set a delegating password and delegating authority for the matched account in response to a setting operation of the user/administrator when the received account information matches one of the account information of the accounts in the database, and set the delegating password and the delegating authority for the matched account when the user/administrator has the authority, wherein the delegating authority defines at least one authorized operation;
a password comparing module configured to compare the received password with the user password or the delegating password to determine whether the received password is the user password or the delegating password; and
an operation management module configured to implement an operation in response user operations when the received password is the user password or one of the at least one the authorized operation in response agent operations when the received password is the delegating password.

2. The account management system as described in claim 1, wherein the delegating authority setting module is configured to determine whether the received password matches the user password or an administrative password to determine whether the user/administrator has the authority to set a delegating password and delegating authority for the matched account.

3. The account management system as described in claim 1, wherein the plurality of modules further comprises a mode determining module, the mode determining module is configured to determine whether the matched account has the delegating password, and display a user mode and delegating mode when the matched account has the delegating password, the password comparing module determines whether the received password matches the user password when the user chooses the user mode, the operation managing module implements the operation for the account in response to user operations when the received password matches the user password, the password comparing module determines whether the received password matches the delegating password when the user chooses the delegating mode, the operation managing module implements the at least one authorized operation for the account in response agent operations when the received password matches the delegating password.

4. The account management system as described in claim 1, wherein the password comparing module compares the received password with the user password and the delegating password respectively when the account has the user password and the delegating password, and determines the received password is the user password when the received password matches the user password or the received password is the delegating password when the received password matches the delegating password.

5. The account management system as described in claim 1, wherein the delegating authority is configured to store a start time for implementing the authorized operation and an end time for ending the authorized operation, the operation managing module is further configured to determine whether current time is between the start time and the end time when the received password matches the delegating password, and implement the authorized operation for the account in response agent operations when the current time is between the start time and the end time.

6. The account management system as described in claim 1, wherein delegating authority is further configured to store a limited value for exchange traded funds, the operation managing module is further configured to determine whether current exchange traded funds is less than the limited value of the exchange traded funds when the received password matches the delegating password, and implement the authorized operation for the account in response to agent operations when the current exchange traded funds is less than the limited value of the exchange traded funds.

7. The account management system as described in claim 1, wherein the delegating authority is further configured to store a predetermined time of use of the delegating operation and a current time of use of the delegating operation, the operation managing module is further configure to increase the current time of use time one when the received password matches the delegating password, determine whether the current time of use is less than the predetermined time of use, and implement the authorized operation for the account in response to agent operations when the current time of use is less than the predetermined time of use.

8. An account management method implemented by an account management system which comprises at least one processor to execute a plurality of steps, wherein the plurality of steps comprises:
storing a plurality of accounts and a user password for each of the plurality of accounts to a database;
receiving account information, and determining whether the received account information matches one of account information of the accounts in the database;
receiving a password when the received account information matches one of the account information of the accounts in the database;
validating whether a user/administrator has an authority to set a delegating password and delegating authority for the matched account in response to a setting operation of the user/administrator when the received account information matches one of the account information of the accounts in the database, and setting the delegating password and the delegating authority for the matched account when the user/administrator has the authority, wherein the delegating authority defines at least one authorized operation;
comparing the received password with the user password or the delegating password to determine whether the received password is the user password or the delegating password; and
implementing an operation in response to user operations when the received password is the user password or one of the at least one authorized operation in response to agent operations when the received password is the delegating password.

9. The account management method as described in claim 8, wherein the plurality of steps further comprises:
determining whether the received password matches the user password or an administrative password to determine whether the user/administrator has the authority to set a delegating password and delegating authority for the received account.

10. The account management method as described in claim 8, wherein the plurality of steps further comprises:
determining whether the matched account has the delegating password, and displaying a user mode and a delegating mode when the received account has the delegating password;
determining whether the received password matches the user password when the user chooses the user mode, and implementing the operation for the account in response to user operations when the input password matches the user password; and
determining whether the received password matches the delegating password when the user chooses the delegating mode, and implementing the authorized operation for the account in response to agent operations when the received password matches the delegating password.

11. The account management method as described in claim 8, wherein the plurality of steps further comprises:
comparing the received password with the user password and the delegating password respectively when the account has the user password and the delegating password; and
determining the received password is the user password when the received password matches the user password or the received password is the delegating password when the received password matches the delegating password.

12. The account management method as described in claim 8, wherein the plurality of steps further comprises:
storing a start time for implementing the authorized operation and an end time for ending the authorized operation in the delegating authority;
determining whether current time is between the start time and the end time when the received password matches the delegating password; and
implementing the authorized operation for the account in response to agent operations when the current time is between the start time and the end time.

13. The account management method as described in claim 8, wherein the plurality of steps further comprises:
storing a limited value for exchange traded funds in the delegating authority;
determining whether current exchange traded funds is less than the limited value of the exchange traded funds when the received password matches the delegating password; and
implementing the authorized operation for the account in response to agent operations when the current exchange traded funds is less than the limited value of the exchange traded funds.

14. The account management method as described in claim 8, wherein the plurality of steps further comprises:
storing a predetermined time of use of the delegating operation and a current time of use of the delegating operation in the delegating authority;
increasing the current time of use time one when the received password matches the delegating password;
determining whether the current time of use is less than the predetermined time of use; and
implementing the authorized operation for the account in response to agent operations when the current time of use is less than the predetermined time of use.
